(19) United States
(12) Patent Application Publication
(10) Pub. No.: US 2026/0158458 A1
(43) Pub. Date: Jun. 11, 2026

(54) CONTAINERS, METHODS OF PREPARING A CONTAINER, AND METHODS OF MIXING A LIQUID SLURRY IN THE CONTAINER

(71) Applicant: ENTEGRIS, INC., Billerica, MA (US)

(72) Inventors: Riley Thiesfeld, Carver, MN (US); Michael W. Johnson, St. Louis Park, MN (US); Marc A. Maxim, Batavia, IL (US)

(21) Appl. No.: 19/409,610

(22) Filed: Dec. 4, 2025

Related U.S. Application Data
(60) Provisional application No. 63/728,603, filed on Dec. 5, 2024.

(51) Int. Cl. B01F 35/53; B01F 23/50; B01F 27/113

(52) U.S. Cl. CPC B01F 35/5312; B01F 23/511; B01F 27/113

(57) ABSTRACT

Described are containers and methods of mixing a slurry such as a CMP slurry in a container, the container comprising baffles to allow the slurry to be mixed to a uniform distribution within the container, while forming not more than a minimum vortex.

### FIELD

Described are containers and methods of mixing a slurry such as a CMP slurry in a container, the container having one or more baffles on a sidewall to allow different volumes of the slurry to be mixed to a uniform distribution within the container, while forming not more than a minimum vortex.

### BACKGROUND

Processes used to prepare microelectronic and semiconductor devices involve steps referred to as “chemical-mechanical processing” or “chemical mechanical polishing,” or, generally, “CMP processes.” In these processes, a dilute liquid (typically aqueous) “slurry” (e.g., a “CMP slurry”) that contains a combination of chemical ingredients and very small abrasive particles is applied to a device surface with motion and pressure applied by a specialized pad (a “CMP pad”). By a combination of mechanical (abrasive) action and chemical action, the chemicals and abrasive particles of the slurry, with pressure and motion between the pad and the device surface, are effective to remove very small amounts of material from the surface of the device.

To precisely remove the material from the device surface, operating conditions of a CMP process are very closely and precisely controlled. These include: the pressure of a CMP pad applied to a device surface; movement of the CMP pad over the device surface; the amount of time of use and the physical condition of the CMP pad surface; and the chemistry and amounts of ingredients in the CMP slurry. The slurry, for example, contains very precise amounts of water, suspended abrasive particles, and dissolved chemicals, and even a slight variation from a desired concentration of these ingredients in the slurry can negatively affect the CMP process.

CMP slurries are commercially transported and stored in large containers such as 55 gallon drums. For use in a CMP process, the container filled with slurry is connected to a CMP tool and small amounts of slurry are periodically removed from the container and delivered to a CMP process as needed. The container holds an initial volume of slurry that has a very precisely-determined concentration of ingredients, including an initial concentration of abrasive particles (referred to as an “initial concentration” of abrasive particles) that is correct for use in a CMP process with which the slurry will be used. During use of the slurry in the container, discrete amounts of the slurry are periodically removed from the container and delivered to the CMP process, e.g., amounts in a range of milliliters, and the volume of slurry in the container is gradually reduced over a period of days, weeks, or months. The concentration of abrasive particles in each amount of the slurry delivered to a CMP process over this time should be the same as this initial concentration. The “initial concentration” can also be referred to as a “target concentration” of the subsequent amounts of slurry removed from the container over time.

Between the periodic removal of slurry from the container, the abrasive particles of the slurry can settle at the bottom of the container, or, less obviously, can become stratified within the slurry due to gravity and become concentrated in a volume of slurry located at a bottom portion of the slurry, even without becoming settled at the container bottom. Settling or stratification of the abrasive particles within a volume of slurry located at a lower portion of the container produces a difference in the concentration of abrasive particles throughout the volume of slurry in the container. A lower portion of slurry will contain a higher concentration of abrasive particles, and an upper portion of slurry will contain a lower concentration of abrasive particles. To eliminate these differences in concentrations of the abrasive particles in the slurry, and to deliver slurry from the container with a consistent concentration of abrasive particles (the target concentration), even as slurry is removed from the container, the slurry can be periodically mixed within the container to re-distribute the abrasive particles throughout the slurry.

### SUMMARY

To redistribute abrasive particles in a volume of CMP slurry (“slurry,” herein) in a container, after settling or stratification, the slurry can be mixed within the container. Mixing should produce an even or uniform concentration of abrasive particles throughout the volume of slurry held in the container. However, certain methods of mixing a slurry in the container can produce a vortex. A vortex can cause poor mixing results, including a non-uniform distribution of abrasive particles throughout the volume of slurry being mixed. In particular, when a vortex forms, the vortex can force abrasive particles to remain at a bottom portion of the volume of slurry being mixed, at a bottom of the container, where the abrasive particles can collect. The vortex can result in a significantly greater concentration of abrasive particles at a lower portion of the volume of slurry in the container, and a lower concentration of abrasive particles at an upper portion of the volume of slurry.

A vortex may form in a container that is full, i.e., contains an initial volume of slurry that fills most of the container. Vortex formation becomes more likely as the container is emptied, as amounts of slurry are periodically removed from the container. But to consistently deliver slurry that has a desired target concentration of abrasive particles, the CMP slurry must be mixed to have uniformly-distributed abrasive particles both when the container is full, and also when the container holds gradually smaller volumes of slurry, after amounts of slurry are periodically and gradually removed from the container. The concentration of abrasive particles in the slurry delivered to the CMP process must be the same target concentration whether the container is full (contains a “full-volume” of slurry) or is partially full (contains a “partially-full volume”) of slurry. Accordingly, the volume of slurry in the container must be effectively mixed to a similar uniformity, with abrasive particles being uniformly distributed within the slurry, regardless of the volume of slurry in the container.

As described, a container can include baffles to produce uniform mixing of slurry within the container, with minimal or no vortex formation, and with different volumes of slurry being held in the container. Various baffle designs exist to improve mixing of liquids having a range of chemical compositions, viscosities, and in containers of different sizes (volumes). A particular challenge for delivering CMP slurries from a container is that suspended abrasive particles must be uniformly distributed within the slurry when the container contains a full amount of slurry, and also when the container contains a partially-full amount of slurry, to consistently deliver slurry having a target concentration of abrasive particles to a CMP process.

To use a container that is initially filled with CMP slurry, an amount of slurry is initially removed from the container for use in a CMP process. The initial amount of slurry contains an initial concentration of abrasive particles, but is normally mixed inside of the container to evenly distribute the abrasive particles throughout the slurry before delivering slurry to the CMP process. An amount of time may pass before another amount of the slurry is removed, during which time the abrasive particles may settle or stratify within the remaining volume of slurry. Before removing an additional amount of slurry from the container, the slurry must again be mixed to re-disperse the abrasive particles evenly within the slurry and deliver slurry to the CMP process that has the same concentration as the initial concentration, which may be referred to as the target concentration. After each removal, another period of time passes that again allows settling or stratification of the particles in the slurry, and mixing is again required before another amount of slurry having the target concentration of abrasive particles can be removed. As amounts of slurry are gradually removed from the container, the volume of slurry remaining in the container is gradually reduced. With smaller and smaller volumes of slurry remaining in the container, each remaining volume of slurry more easily forms a vortex when mixed. However, the need to deliver the slurry to the CMP process with the same target concentration of abrasive particles remains the same.

In one aspect, the description relates to a method of mixing a slurry that contains suspended abrasive particles and dissolved chemical ingredient. The method includes: in a container that includes a top, a bottom, a cylindrical sidewall extending along a sidewall height between the top and the bottom, and a container interior defined by the top, the bottom, and the sidewalls, the container interior having an interior volume; one or more baffles extending from the sidewall into the container interior; and a volume of slurry in the interior; mixing the volume of slurry within the container interior to produce no more than a minimum vortex in the slurry, while achieving a distribution of the abrasive particles in the volume of slurry that includes at least 30 percent of the abrasive particles located within the top half of the volume of slurry.

In another aspect, the invention relates to a molded container that includes: a top, a bottom, a cylindrical sidewall extending along a sidewall height between the top and the bottom, and a container interior defined by the top, the bottom, and the sidewalls, the container interior having an interior volume; a cover at the top; slurry in the container interior; and one or more baffles extending from the sidewall into the container interior, the one or more baffles being effective to mix the slurry within the container interior to produce no more than a minimum vortex in the slurry, while achieving a distribution of the abrasive particles in the volume of aqueous slurry that includes at least 30 percent of the abrasive particles located within the top half of the volume of slurry.

In yet another aspect, the invention relates to a method of forming a blow molded container. The method includes: placing a cylindrical parison in mold cavity, the cylindrical parison having a hollow interior and a flowable thermoplastic sidewall, the mold cavity including a cavity bottom, a cylindrical cavity sidewall extending vertically from the bottom and having a height, and extensions on the sidewall extending along a portion of the height; and dispensing air into the hollow interior of the parison to cause the thermoplastic sidewalls to expand to contact the mold interior.

### BRIEF DESCRIPTION OF THE DRAWINGS

FIG. 1 shows an example container adapted to include one or more baffles as described.

FIG. 2 shows a container and a mixing apparatus as described.

FIGS. 3A and 3B show an example baffle as described.

FIGS. 4A, 4B, and 4C show examples of containers and baffles as described.

The figures are exemplary and are not necessarily to scale.

### DETAILED DESCRIPTION

Described are containers that are useful for containing a slurry used in a CMP process, and methods of mixing the slurry in the container. A container includes one or more baffles to minimize or prevent the formation of a vortex in the slurry while mixing different volumes of slurry, to contain a uniform distribution of abrasive particles. Baffle designs and baffle arrangements at the sidewalls of the container can be effective to minimize or prevent the formation of a vortex when the container is full, and are also effective to minimize or prevent the formation of a vortex when the container is not full, i.e., is only partially-full with slurry.

The CMP slurry contains: water; chemical ingredients dissolved in the water (e.g., catalyst, surfactant, inhibitor, stabilizer, etc.) typically in an amount between about 0.1 and 10 weight percent based on total weight of the slurry; and dispersed abrasive particles typically in an amount of between 1 and 10 weight percent of the weight of the slurry.

A slurry held in a container will experience settling or stratification of abrasive particles in the slurry during storage or use, sometimes within a matter of hours, e.g., in as short as 3 or 6 hours, to a degree that produces a difference in the concentration of abrasive particles within a volume of slurry in the container, i.e., an “intra-volume” concentration gradient within the volume of slurry in the form of a higher concentration of abrasive particles in a lower portion of the slurry volume and a lower concentration of abrasive particles in an upper portion of the slurry volume. Examples of abrasive particles that may exhibit relatively rapid settling or stratification within a volume of slurry include alumina particles, ceria particles, titania particles, zirconia particles, diamond particles, and silica (fumed or precipitated) particles.

Slurry is delivered to a CMP process from the container by periodically removing small individual volumes (e.g., amounts in a range of milliliters) of the slurry from the container over a period of hours, days, or weeks. For consistent performance of a CMP process, each amount of slurry delivered to the CMP process from a single container should contain the same concentration of abrasive particles (a target concentration), even as amounts of slurry are gradually removed from the container. A “target concentration” of abrasive particles in slurry delivered to the CMP process should be at least approximately equal to an initial concentration of abrasive particles in a full container, e.g., within 1 percent of the initial concentration; for example, if the initial concentration of abrasive particles in a slurry is 5 percent by weight (of the slurry), slurry delivered at a target concentration should be in a range from 4.95 to 5.05 percent by weight of the slurry.

A container as described includes a baffle or baffles that allow for effective mixing of a volume of slurry in the container to uniformly distribute abrasive particles throughout the volume of slurry. The baffles allow for effective mixing of slurry when the container contains a full-volume of slurry, and also allow for effective mixing of the slurry when the container contains less than a full volume of slurry, periodically, as slurry is gradually removed from the contain. The one or more baffles provide effective mixing of the slurry to uniformly distribute abrasive particles within the slurry, while minimizing or preventing the formation of a vortex and while the container contains a either a full-volume of the slurry or a partially-full volume of the slurry.

The shape, size, and location of a baffle or of baffles in a container can be effective to allow for uniform mixing and a minimum vortex or no vortex, while different volumes of slurry are contained in the container, including from a full-volume of slurry to various partially-full volumes of slurry. A full-volume of slurry in a container may be volume of slurry in the container that is at least 80, 90, or 95 percent of the total volume of the container interior. A partially-full volume of slurry in a container may be volume of slurry in the container that is at less than 60 or 50 percent of the total volume of the container interior, e.g., a volume of slurry that takes up from 15, 20, or 25 percent, to 40, 50, or 60 percent, of the total volume of the container interior.

The container can be any container that is of a type that is useful to contain CMP slurry for storage and transportation, and to deliver the CMP slurry from the container to a CMP process. Example containers are commercially known and may be referred to as “drums” or “55 gallon drums,” although the present methods and containers are not limited to these exemplary containers and other versions of containers with alternate shapes and volumes (larger and smaller) will also be useful according to this description. Example containers may have an interior volume in a range from 40 to 60 gallons. The container may be made of any useful material, such as a polymer, including thermoplastics. Example polymers include polyolefins (e.g., polyethylene) and fluoropolymers (e.g., perfluoroalkoxy alkanes or “PFAs”).

An example container may be generally cylindrical, having a cylindrical sidewall that extends circumferentially (360 degrees) and vertically (in a height direction or z-direction), and has a central longitudinal axis that extends vertically along a center of the cylindrical sidewall. The sidewall may be substantially vertical, optionally straight or curved, extends between a top of the sidewall (“sidewall top”) and a bottom of the sidewall (“sidewall bottom”) that correspond to a container top and a container bottom, and has a height (the “sidewall height”) between the sidewall bottom and the sidewall top. The container can include a horizontally-extending (in the x-direction and the y-direction) bottom (“container bottom”) that engages and seals the container at the bottom of the sidewall, and a horizontally-extending top (“container top” or “cover”) at the top of the sidewall that engages and seals the container at the top of the sidewall. The container includes a container interior having an interior volume defined by the container top, the container bottom, and the sidewalls. Optionally, and as is typical, the cover has one or more openings (sometimes referred to as “ports”) that can be opened while the cover remains in place to allow access to the container interior, through the opening, for a purpose of filling the container, removing slurry from the container, or to insert a mixing device into the container to mix the slurry within the container.

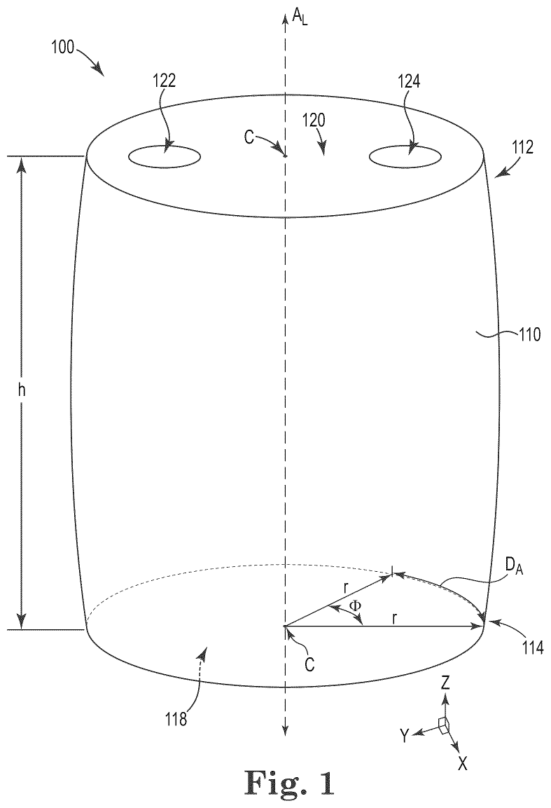

FIG. 1 shows example container 100 that includes generally cylindrical but slightly-curved sidewall 110 extending circumferentially (360 degrees) and vertically, and defining a central (longitudinal) axis (A_{L}) that extends vertically at a center-line of cylindrical sidewall 110. Sidewall 110 includes sidewall top 112 and sidewall bottom 114. Horizontally-extending cover 120 engages sidewall top 112 to form a seal between cover 120 and sidewall top 112. Cover 120 includes two openings 122, 124, each being adapted to engage a plug (not specifically illustrated) that can be removed from opening 122, 124 to allow access to the interior of container 110, and optionally replaced to re-seal the container at opening 122, 124. Container 100 also includes horizontally-extending bottom 118 that engages sidewall bottom 114 to form a seal between bottom 118 and sidewall bottom 114. Container 100 as illustrated does not include a baffle but can be adapted to include one or more baffles for use according to the present description.

The shape and dimensions of a container, e.g., 100, can be described using Cartesian coordinates (x, y, z, for length, width, and height, as referenced previously) and may also be described using cylindrical coordinates. Accordingly, a cylindrical container and components thereof, including a baffle, may have a height dimension (e.g., sidewall height “h” at FIG. 1) defined as a vertical (in a z-direction) dimension of a container or component thereof such as a sidewall or baffle. A cylindrical container or a component thereof may have a radial dimension (“r” as shown at FIG. 1) or location defined by a length of a radial line or a length of a portion of a radial line that originates at central axis A_{L} or center C of the cylindrical container and extends horizontally from the central axis. The container or a component of the container has an “angular dimension” (“D_{A}”) that is equal to a length of an arc between two horizontal radial lines extending from central axis A_{L} that have an angle (phi, Φ) therebetween, at a specific radius.

The container includes one or more baffles that allow a volume of slurry held in the container to be mixed within the container to achieve a uniform distribution of abrasive particles in the volume of slurry, with minimal or no vortex forming, and with different volumes of slurry (a full-volume of slurry, a partially-full volume of slurry) in the container. A volume of slurry in a container is considered to be uniformly mixed and to have a uniform distribution of abrasive particles within the volume of slurry if a concentration of abrasive particles in an upper portion of the volume of slurry is substantially the same as a concentration of abrasive particles at a lower portion of the volume of slurry. In specific, a volume of slurry is considered to have a uniform distribution of abrasive particles within the slurry if at least 30, 35, 40, 45, or 50 percent of abrasive particles in the slurry are located in an upper half of the volume slurry, and not more than 50, 55, 60, 65, or 70 percent of abrasive particles located in a bottom half of the volume of slurry.

The described containers and methods are useful to mix a volume of slurry in a container to produce a uniform distribution of abrasive particles within the volume slurry, without forming a vortex or with the formation of only a minimal vortex. As used herein, the term “vortex” refers to a condition during mixing of a slurry in a container that results in a rotating mass of slurry in the container, wherein the rotating mass of slurry produces an empty space or depression within the rotating mass, at the surface of the slurry, and produces a force of suction that is sufficient to draw gaseous atmosphere present above the liquid into the liquid. The magnitude of the slurry can be measured by the depth of the depression formed in the rotating mass. As used herein, a vortex is considered to be a “minimal” vortex if the maximum depth at the depression is less than 3 centimeters, e.g., less than 2 or 1 centimeter. A mixing process is considered to produce no vortex if the mixing process produces a vortex that has a maximum depth at the depression that is less than 0.5 centimeter.

Normally, a CMP slurry is initially contained in a container in an amount that nearly fills the interior volume of the container, measured based on the maximum volume of the container interior. This amount of slurry in a container is referred to as an “initial volume” or a “full-volume,” and can be a volume of slurry that is at least 80, 90, or 95 percent of the interior volume of the container. The initial volume of slurry contains a specific concentration of abrasive particles, referred to as an “initial concentration” of abrasive particles in the slurry.

During use to supply the slurry to a CMP process, the container will hold a gradually-reduced volume of slurry. As amounts of slurry are periodically removed from the container, the container is considered to contain a partially-full volume of slurry. A partially-full volume of slurry in a container may be volume that is at less than 60 or 50 percent of the total volume of the interior volume of the container, e.g., a volume of slurry that takes up from 15, 20, or 25 percent, to 40, 50, or 60 percent, of the total volume of the container interior.

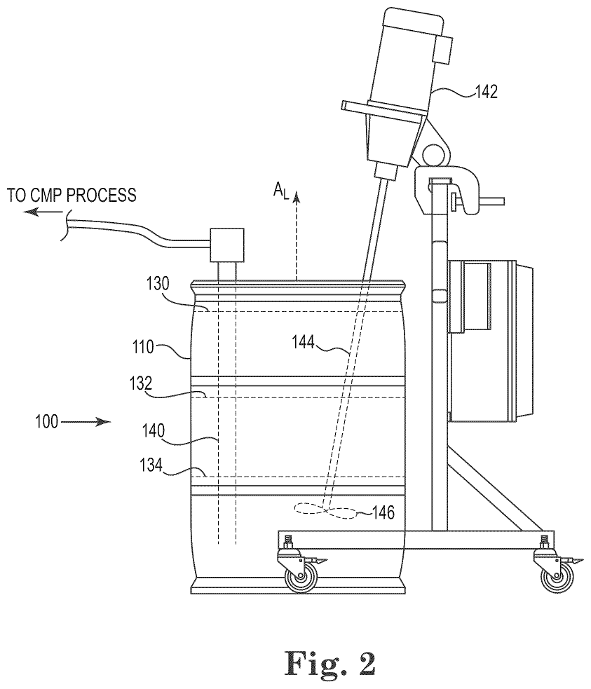

According to a typical design, e.g., as shown at FIG. 2, a container 100 includes an initial volume of slurry (a full-volume, indicated by level 130), having an initial concentration of abrasive particles. An elongate dip tube 140 is inserted through an opening in a cover of container 100 to extend an open intake end of the dip tube to a location near the bottom of the container interior. A mixer 142, having a shaft 144 and an impeller blade 146 is inserted through another opening in the cover to place the impeller blade at a location at a lower portion of the container interior. At different times during the periodic removal of slurry from the container, the mixer is used to mixed and uniformly distribute abrasive particles throughout the volume of slurry contained in container 100.

During transport or storage of a container, abrasive particles in a slurry can settle or become stratified within the container due to gravity. This creates an intra-volume gradient in the concentration of abrasive particles at different portions of the volume of slurry in the container, when the container holds a full-volume of slurry, represented by line 130. Settling or stratification of the abrasive particles causes a higher concentration of abrasive particles to be present at a lower portion of the slurry or at the bottom of the container, and a lower concentration of abrasive particles to be present at upper portions of the slurry. With the container holding a full-volume of slurry, the slurry can be mixed in a container as described, with one or more baffles, to re-distribute the abrasive particles within the volume of slurry to a uniform distribution of the abrasive particles within the volume of slurry. With the abrasive particles uniformly distributed in the slurry, an amount of slurry that has an initial concentration of abrasive particles can be removed from the container.

Subsequently, with container 100 attached to the CMP process, amounts of slurry are periodically removed from the container and delivered to the CMP process. When each amount of slurry is removed from the container, the slurry should have a target concentration of abrasive particles that is the same as (or approximately the same as) the initial concentration of abrasive particles. As described herein, a partially-full volume of slurry in the container can be mixed in the container to distribute the abrasive particles uniformly throughout the slurry. With the abrasive particles uniformly distributed in the reduced volume of slurry in the container, an amount of slurry that has a desired target concentration of abrasive particles can be removed from the container.

Referring again to FIG. 2, according to example methods, amounts of slurry can be removed from a container (e.g., 100), and a remaining partially-full volume of slurry in the container, indicated by line 132, can be mixed within the container with a minimal vortex or no vortex to produce a uniform distribution of abrasive particles within the volume of slurry. The partially-full volume of slurry may be a volume of slurry that is in a range of from 40 to 60 percent of the total volume of the container interior. Additional amounts of slurry can be subsequently removed from the container (e.g., 100), and a remaining partially-full volume of slurry in the container, e.g., as indicated by line 134, can be mixed within the container with a minimal vortex or no vortex, to produce a uniform distribution of abrasive particles within the volume of slurry. The partially-full volume of slurry may be a volume of slurry that is in a range of from 10, 15, or 20 to 30 or 40 percent of the total volume of the container interior. With mixing of the slurry to uniformly distribute abrasive particles in a partially-full volume of slurry, e.g., as shown by line 32 or 34, slurry that is removed from the container having different partially-full volumes of slurry can consistently contain a desired target concentration of abrasive particles.

A useful baffle designs and a useful baffle arrangement can be any that are effective to perform uniform mixing of a slurry while minimizing or preventing the formation of a vortex, when the container contains a full-volume of slurry or a partially-full volume of slurry. Example baffles may be oriented vertically along a portion of a height of an interior sidewall of the container, may be located at regular intervals around the inner circumference of the interior, and may be at the same, different, or overlapping horizontal portions of the height of the sidewall.

A baffle may have an elongate dimension that extends along a portion of a height of a sidewall, and may have any useful geometric cross section such as rectangular, square, rounded, curved, angled, semi-circular, rectangular etc. According to specific, non-limiting examples, a baffle may have a “crowned” cross-section, meaning a cross-sectional profile that includes a base that connects to the sidewall of the container, a baffle body that extends laterally toward the container interior to an end of the baffle, and width dimension at the base that is greater a width dimension of the body.

A baffle has a vertical height dimension that extends vertically along a portion of a height of the sidewall; an angular dimension, referred to as the baffle “width,” (D_{A}, at FIG. 1) that extends a distance along an arc about the center of the container; and a “thickness” dimension (“t”) that extends horizontally away from the sidewall and baffle base along a radius of the container, toward the container interior. A crowned baffle has a width at the base, a thickness extending into the container, and a body that has a width that is less than the width at the base. A crowned baffle may have a cross-section that is triangular (curved or pointed), a semi-circular cross section, or an otherwise curved or angled cross section with a reduced width of the body relative to the base.

A baffle may have any useful height extending along a portion of a height of a sidewall, and one or more baffles may have the same or different heights, and may be located at the same or different portions of the height of a sidewall. Example baffles may extend substantially the entire height of a sidewall, e.g., from 75 to 90 percent of a height of a sidewall. Alternate baffles may extend along a smaller portion of the height of a sidewall, such as from 10 to 60 or 20 to 50 percent of a height of a sidewall.

A baffle may have any useful width or width profile. Example baffles can have a width, at the base, width that extends along from 1 to 10 percent of a circumference of a container, or from 2 to 7 percent of a circumference of a container.

A baffle may have any useful thickness, such as from 3 to 15 percent of a diameter of a container, or from 5 to 10 percent of a diameter of a container.

A baffle may be a component that is produced separately from the container and container sidewall and that is attached to the container sidewall at the container interior, for example by an adhesive or a mechanical fastener. In alternate containers, a baffle may be a shape feature of the sidewall itself that is fabricated integrally with the sidewall, with the sidewall and baffle being formed by and during a single manufacturing process, such as by a molding (e.g., blow molding) process.

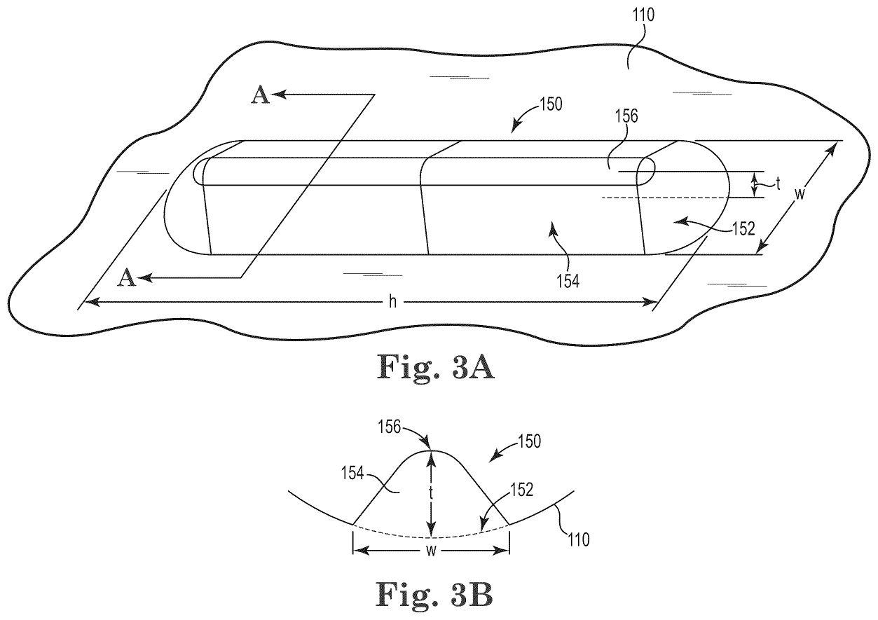

Referring to FIGS. 3A and 3B, FIG. 3A is a side perspective view of an example baffle 150 attached to or incorporated into sidewall 110, and FIG. 3B is a top, cross-sectional view of baffle 150 attached to or incorporated into sidewall 110. Baffle 150 may be a separate piece that is prepared separately from sidewall 110 and attached to sidewall 110, e.g., by an adhesive, or may be an integral structure of sidewall 110 prepared simultaneously with sidewall 110, e.g., by a molding process. Baffle 150 includes base 152, body 154, and end 156. The width dimension (“w”) is larger at base 152 and smaller at end 156 and has a crowned, generally triangular shape in cross-section.

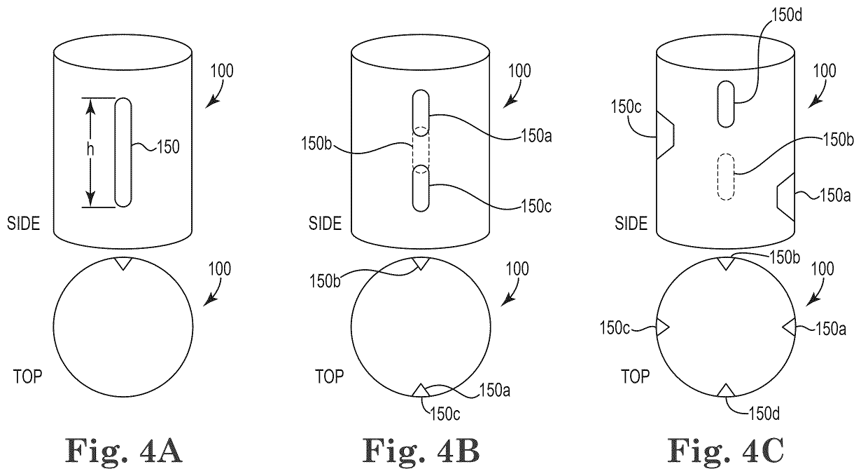

Examples of useful baffle designs and baffle arrangements in a container are shown at FIGS. 4A, 4B, and 4C.

FIG. 4A (side view and top view) shows a drum 100 (a 55 gallon drum) with a single baffle 150 located vertically on sidewall 110, along approximately 80 percent of a middle portion of the height of the sidewall. Baffle 150 has a crowned (triangular as illustrated) cross-section, a thickness that is approximately 1/12 of the inner drum diameter, a width that is from approximately 0.5 to 3 inches, and a height (h) of approximately 19.5 inches. Using an impeller mixer (A310 axial flow impeller) at 1500 revolutions per minute (RPMs) this container and baffle arrangement allowed a full-volume of slurry to be mixed in the container for at least 5, 10, or 20 minutes with minimal vortex, which was an amount of time effective to produce uniform distribution of abrasive particles throughout the slurry.

FIG. 4B (side view and top view) shows a drum 100 (a 55 gallon drum) with three baffles 150a, 150b, and 150c located on sidewall 110 at 180 degrees opposite angular locations on the sidewall circumference. Each baffle has a crowned (triangular as illustrated) cross-section, a width that is approximately 0.5 to 3 inches, a thickness that is approximately 1/12 of the inner drum diameter, and a height (h) of approximately 10.5 inches. The three baffles are located at different portions of the height of the sidewall, with baffles 150a and 150c located on one side (a front side as illustrated) of the container at an upper height portion and at a lower height portion, and the third baffle located at the opposite angular location (a back side) of the container and at a middle height portion. Using an impeller mixer (A310 axial flow impeller) at 1500 revolutions per minute (RPMs) this container and baffle arrangement allowed a full-volume of slurry to be mixed in the container for at least 5, 10, or 20 minutes with no vortex, which was an amount of time that is effective to produce uniform distribution of abrasive particles throughout the slurry. Slurry was removed from the container and with a partially-full volume of slurry in the container (a volume of approximately one-half of the container volume), using an impeller mixer (A310 axial flow impeller) at 1500 revolutions per minute (RPMs), this container and baffle arrangement allowed the partially-full volume of slurry to be mixed in the container for at least 5, 10, or 2 minutes with minimal vortex, which was an amount of time effective to produce uniform distribution of abrasive particles throughout the slurry.

FIG. 4C (side view and top view) shows a drum 100 (a 55 gallon drum) with four baffles 150a, 150b, 150c, and 150d located on sidewall 110 at 90 degrees intervals on the sidewall circumference. Each baffle has a crowned (triangular as illustrated) cross-section, a width that is approximately 0.5 to 3 inches, a thickness that is approximately 1/12 of the inner drum diameter, and a height (h) of approximately 10.5 inches. The four baffles are located at different height portions of the sidewall, with baffle 150a being at a lower height portion, baffle 150b being at lower-middle height portion, baffle 150c being at an upper middle height portion, and baffle 150d being at an upper height portion. Using an impeller mixer (A310 axial flow impeller) at 1500 revolutions per minute (RPMs) this container and baffle arrangement allowed a full-volume of slurry to be mixed in the container for at least 5, 10, or 20 minutes with no vortex, which was an amount of time that is effective to produce uniform distribution of abrasive particles throughout the slurry. Slurry was removed from the container and with a partially-full volume of slurry in the container (a volume of approximately one-half of the container volume), using an impeller mixer (A310 axial flow impeller) at 1500 revolutions per minute (RPMs), this container and baffle arrangement allowed the partially-full volume of slurry to be mixed in the container for at least 5, 10, or 20 minutes with no vortex, which was an amount of time effective to produce uniform distribution of abrasive particles throughout the slurry.

According to one example method, a container with one or more baffles can be prepared by a molding process such as a blow molding process. Generally, blow molding methods are known for producing hollow thermoplastic articles such as bottles, drums, and other containers. Example steps include heating a thermoplastic to form a parison, which a tube-like piece of plastic with a hole in one end through which compressed air can enter. The parison can then be clamped into a mold, and air is blown into the parison interior. The mold includes a cavity having a cavity bottom and a cylindrical cavity sidewall extending vertically from the bottom along a cavity height. The mold also includes one or more vertical baffle extensions on the sidewall extending along a portion of the height. The one more vertical baffle extensions are sized and arranged according to baffles of a container described herein. As air pressure in the parison interior causes the parison to expand, the sides of the parison are pressed against the cylindrical cavity sidewall and the sidewalls are formed to include one or more baffles of the present description.

1. A method of mixing a slurry that contains suspended abrasive particles and dissolved chemical ingredient, the method comprising:
in a container that comprises
a top, a bottom, a cylindrical sidewall extending along a sidewall height between the top and the bottom, and a container interior defined by the top, the bottom, and the sidewalls, the container interior having an interior volume,
one or more baffles extending from the sidewall into the container interior,
a volume of slurry in the interior,
mixing the volume of slurry within the container interior to produce no more than a minimum vortex in the slurry, while achieving a distribution of the abrasive particles in the volume of slurry that includes at least 30 percent of the abrasive particles located within the top half of the volume of slurry.

2. The method of claim 1, comprising:
with a volume of slurry that is at least 80 percent of the interior volume, mixing the volume of slurry within the container interior to produce no more than a minimum vortex in the slurry, while achieving a distribution of the abrasive particles in the volume of aqueous slurry that includes at least 30 percent of the abrasive particles located within the top half of the volume of slurry,
removing slurry from the container, and
with the container containing a volume of slurry that is less than 60 percent of the interior volume, mixing the volume of slurry within the container interior to produce no more than a minimum vortex in the slurry, while achieving a distribution of the abrasive particles in the volume of aqueous slurry that includes at least 30 percent of the abrasive particles located within the top half of the volume of slurry.

3. The method of claim 1, the container comprising:
a first baffle along a first portion of the sidewall height,
a second baffle along a second portion of the sidewall height, and
a third baffle along a third portion of the sidewall height.

4. The method of claim 3 wherein the first baffle is located at a first angular location of the sidewall, the second baffle is located at a second angular location of the sidewall, and the third baffle is located at a third angular location of the sidewall, the first angular location being approximately the same as the second angular location, and the third angular location being approximately 180 degrees from the first angular location.

5. The method of claim 3, comprising:
with the container containing a volume of slurry that is at least 80 percent of the interior volume, mixing the volume of slurry for at least 10 minutes within the container interior to produce no vortex in the slurry,
removing slurry from the container, and
with the container containing a volume of slurry that is less than 60 percent of the interior volume, mixing the volume of slurry for at least 10 minutes within the interior to produce no more than a minimum vortex in the slurry.

6. The method of claim 1, the container comprising:
a first baffle along a first portion of the sidewall height,
a second baffle along a second portion of the sidewall height,
a third baffle along a third portion of the sidewall height, and
a fourth baffle along a fourth portion of the sidewall height, with each baffle being located approximately 90 degrees from two other baffles along the circumference of the container.

7. The method of claim 6, comprising:
with the container containing a volume of slurry that is at least 80 percent of the interior volume, mixing the volume of aqueous slurry for at least 10 minutes within the container interior to produce no vortex in the slurry,
removing slurry from the container, and
with the container containing a volume of slurry that is less than 60 percent of the interior volume, mixing the volume of aqueous slurry for at least 10 minutes within the interior to produce no vortex in the slurry.

8. The method of claim 1, wherein the interior volume is in a range from 40 to 60 gallons and each baffles has:
a height dimension in a range from 10 to 90 percent of the sidewall height,
a width dimension in a range from 2 to 7 percent of a circumference of the container, and
a thickness dimension in a range from 3 to 15 percent of a diameter of the container.

9. The method of claim 1, wherein the aqueous slurry comprises from 1 to 10 weight percent abrasive particles and at least 80 percent water.

10. The method of claim 1, wherein the container and the baffles are prepared as a single piece by a molding process.

11. The method of claim 1, comprising mixing the slurry using an impeller mixer.

12. A molded container comprising:
a top, a bottom, a cylindrical sidewall extending along a sidewall height between the top and the bottom, and a container interior defined by the top, the bottom, and the sidewalls, the container interior having an interior volume,
a cover at the top,
slurry in the container interior, and
one or more baffles extending from the sidewall into the container interior, the one or more baffles being effective to mix the slurry within the container interior to produce no more than a minimum vortex in the slurry, while achieving a distribution of the abrasive particles in the volume of aqueous slurry that includes at least 30 percent of the abrasive particles located within the top half of the volume of slurry.

13. The container of claim 12, comprising:
a first baffle along a first portion of the sidewall height,
a second baffle along a second portion of the sidewall height, and
a third baffle along a third portion of the sidewall height.

14. The container of claim 13, wherein the first baffle is located at a first angular location of the sidewall, the second baffle is located at a second angular location of the sidewall, and the third baffle is located at a third angular location of the sidewall, the first angular location being approximately the same as the second angular location, and the third angular location being approximately 180 degrees from the first angular location.

15. The container of claim 14, comprising:
a first baffle along a first portion of the sidewall height,
a second baffle along a second portion of the sidewall height,
a third baffle along a third portion of the sidewall height, and
a fourth baffle along a fourth portion of the sidewall height, with each baffle being located approximately 90 degrees from two other baffles around a circumference of the container.

16. The container of claim 12, wherein the interior volume is in a range from 40 to 60 gallons and each baffles has:
a height dimension in a range from 10 to 90 percent of the sidewall height,
a width dimension in a range from 2 to 7 percent of a circumference of the container, and
a thickness dimension in a range from 3 to 15 percent of a diameter of the container.

17. The container of claim 12, wherein the container is prepared by a blow molding process.

18. A method of forming a blow molded container, the method comprising:
placing a cylindrical parison in mold cavity,
the cylindrical parison having a hollow interior and a flowable thermoplastic sidewall,
the mold cavity comprising
a cavity bottom,
a cylindrical cavity sidewall extending vertically from the bottom and having a height, and
extensions on the sidewall extending along a portion of the height, and
dispensing air into the hollow interior of the parison to cause the thermoplastic sidewalls to expand to contact the mold interior.

19. The method of claim 18, container comprising:
a first baffle along a first portion of the sidewall height, a second baffle along a second portion of the sidewall height, and a third baffle along a third portion of the sidewall height.

20. The method of claim 19, wherein the first baffle is located at a first angular location of the sidewall, the second baffle is located at a second angular location of the sidewall, and the third baffle is located at a third angular location of the sidewall, the first angular location being approximately the same as the second angular location, and the third angular location being approximately 180 degrees from the first angular location.

21. The method of claim 20, the container comprising:
a first baffle along a first portion of the sidewall height,
a second baffle along a second portion of the sidewall height,
a third baffle along a third portion of the sidewall height, and
a fourth baffle along a fourth portion of the sidewall height, with each baffle being located approximately 90 degrees from two other baffles around a circumference of the container.

22. The method of claim 18, wherein the interior volume is in a range from 40 to 60 gallons and each baffles has:
a height dimension in a range from 10 to 90 percent of the sidewall height,
a width dimension in a range from 2 to 7 percent of a circumference of the container, and
a thickness dimension in a range from 3 to 15 percent of a diameter of the container.
